(19) United States
(12) Patent Application Publication
(10) Pub. No.: US 2026/0167149 A1
(43) Pub. Date: Jun. 18, 2026

(54) SECURITY ALARM

(71) Applicant: Michael HORSFALL, Leeds (GB)

(72) Inventor: Michael Frederick Horsfall, Leeds (GB)

(21) Appl. No.: 19/126,838

(22) PCT Filed: May 26, 2023
(86) PCT No.: PCT/EP2023/064288

§ 371 Date: May 2, 2025

(30) Foreign Application Priority Data
Nov. 2, 2022 (GB) 2216296.0

(51) Int. Cl. B60R 25/10; B60R 25/30

(52) U.S. Cl. CPC B60R 25/1001; B60R 25/30; B60R 2025/1013

(57) ABSTRACT

A security alarm for a vehicle, the security alarm includes a housing having, an inner casing having an aperture extending between interior and exterior surfaces, an outer casing arranged to be secured to the inner casing so that an interior surface of the exterior casing overlies the inner casing exterior surface with the exterior casing covering the aperture, the inner casing exterior surface and the outer casing interior surface defining a spatial volume communicating between the aperture and the inner casing exterior surface and the outer casing interior surface, separated between 1 mm and 5 mm, a base configured to attach the housing to a surface, and a motion sensing component including an audio element and being located within an interior space of the housing so that each audio element is located adjacent an aperture of the casing, the motion sensing component configured to detect movement of the housing and generate an alarm signal.

### BACKGROUND OF THE INVENTION

The present invention relates to a security alarm for a vehicle. More particularly, but not exclusively the present invention relates to a security alarm for a car, van or motorbike. Even more particularly, but not exclusively the present invention relates to a security alarm which may be used for a roof rack or pipe tube carrier attached to a car or van.

Known security alarms comprise motion sensing components which are commonly configured to be attached to the inside of a vehicle. These security alarms are often not suitable for external use.

A problem associated with such security alarms is that the alarm signal is muffled by the interior of the vehicle. Accordingly, the magnitude of the alarm signal has to be increased to compensate for the muffling. Increasing the magnitude of the alarm signal in-turn increases the power consumption of the security alarm. A further disadvantage of locating the security alarm within a vehicle is that the motion sensing component is less responsive to force applied to the exterior of the vehicle, compared with a motion sensing component which is located on the exterior of the vehicle.

UK Patent 2585239 discloses a security alarm for a vehicle.

### SUMMARY OF THE INVENTION

According to the present invention there is provided a security alarm for a vehicle, the security alarm comprising:
a housing having:
   inner and outer casings;
   the inner casing having an interior and an exterior surface, and at least one aperture communicating between the interior and the exterior surfaces;
   the outer casing configured to overlie the inner casing;
   the outer casing having interior and exterior surfaces and arranged to be secured to the inner casing so that the interior surface of the outer casing overlies at least a part of the exterior surface of the inner casing with the outer casing covering the aperture;
   wherein the exterior surface of the inner casing and the interior surface of the outer casing define a spatial volume communicating between the aperture and the exterior surface of the inner casing and the interior surface of the outer casing, the surfaces being separated by a dimension between about 1 mm to about 5 mm;
a base comprising an attachment means to attach the housing to a surface of a vehicle; the casing and the base defining an interior space; and
at least one motion sensing component comprising an audio element, the at least one motion sensing component being located within the interior space of the housing so that each audio element is located adjacent an aperture of the inner casing;
the motion sensing component being configured to detect movement of the housing and to generate an alarm signal from the audio element in response to said movement.

The security alarm according to the invention is configured to be attached to the exterior of a vehicle. The flexible base may be adapted to be biased into a curved configuration by the biasing members when attached to the casing, so that the curvature of the base may be complementary or substantially complementary to the curvature of a region of the vehicle exterior to which the alarm is secured in use. The biasing members may allow for the curvature of the base to be adjusted when the base is attached to the vehicle to provide a better fit to the vehicle exterior.

Attaching the security alarm to a vehicle exterior may also allow for a lower magnitude alarm signal to be used, thereby reducing power consumption, than if the security alarm were fitted inside the vehicle.

The distance or width of a cavity between the surfaces of the inner and outer casings may be substantially constant between the aperture and the outlet to the exterior.

The dimension between the inner and outer casings may be in the range of about 1 mm to about 5 mm, preferably about 1.5 mm to about 2.5 mm, more preferably about 2 mm.

Use of a larger dimension may be disadvantageous due to attenuation of the alarm signal in use.

The space between the inner and outer casings provides an advantage that the outer casing may be resiliently deformed, for example by twisting, during attachment or removal of the outer casing, allowing use of a snap fit arrangement to secure the outer casing to the inner casing. This may avoid a need for fastening screws or bolts. The resilient snap fit arrangement may make manual removal of the outer casing difficult or impossible.

The outer casing may comprise a top panel and one or more sides which extend downwardly from the top panel to form a cover for all of the inner casing or for an upper part of the inner casing. The lower edge or edges of the one or more sides may be straight generally parallel to the base of the inner casing, so that they are located at a constant distance from the surface of a vehicle body in use.

Alternatively, in a preferred embodiment, a lower edge or edges of the one or more sides may be curved, with the ends thereof being closer to the base of the inner casing than an intermediate, for example, central part of the side.

Use of a curved lower edge of a side of the outer casing has the advantage that an alarm signal is emitted in use from the cavity between the inner and outer casings and is directed in a range of angles relative to the body of the alarm. Typically, the alarm sound may be emitted in a direction perpendicular to the edge of the outer casing, so that provision of a curved edge causes the alarm signal to be spread over a range of angles. Reflection of the alarm signal from the adjacent surface of the vehicle body further distributes the alarm signal so that it can be heard from a wide variety of directions relative to the vehicle.

The lower edge may be part circular, elliptical, oval or ovoid in profile. Alternatively, or in addition, the lower edge may be polygonal, segmented, castellated or otherwise shaped to provide surfaces facing in different directions in profile relative to the outer casing. The lower edge may comprise a plurality of curved, angular or angular portions. However, use of a uniformly curved configuration is preferred to improve resistance to tampering.

The dimension between the lower edge or edges and the inner casing is substantially constant and in the range of 1 to 5 mm, preferably 1.5 to 2.5 mm, more preferably, about 2 mm.

The one or more sides of the outer casing may be generally located in parallel spaced relation to corresponding sides of the inner casing, being separated by a distance of 1 mm to 5 mm.

The outer and inner casings may be rectilinear in plan view, having four sides. Alternatively, the outer and inner casings may each be rounded, for example, ovoid or elliptical.

Use of a rectilinear configuration has the advantage that the alarm signal is emitted in four directions from the opening between the inner and outer casings in use.

Alternatively, an increasing dimension between the inner and outer casings may be provided in order to create acoustic amplification of an alarm signal emitted through the aperture.

The dimension of the sound channel along the sides of the alarm unit may increase from a minimum value at an upper position to a maximum value at a lower position adjacent the sound outlet.

The outlet may face towards the base of the alarm.

The outlet may face the surface of the vehicle in use. This arrangement may provide for deflection and scattering of the sound from the alarm, increasing the perceived loudness of the alarm signal.

Provision of the outer casing protects the aperture from obstruction by a would-be thief or other individual and provides an extended outlet for the alarm signal, making it more difficult to muffle the alarm signal.

In embodiments, two apertures may be provided. The apertures may be located on an upper surface of the inner casing, remote from the base. In the absence of the outer casing as in the previous configurations, the location of the aperture or apertures may cause the alarm signal to be emitted away from the vehicle body with a result that the sound may dissipate. In contrast, the present invention causes the sound to be reflected and scattered from the polished surface of the vehicle body.

The outer casing may be secured to the inner casing by one or more screws, clips or other fasteners. Alternatively, or in addition a snap fit connection may be employed. The outer casing is preferably attached securely to the inner casing.

The spacing between the inner and outer casings allows the outer casing to be resiliently deformed as it is attached to or removed from the inner casing and/or base. The space between the casings allows the outer casing to be twisted if removal becomes necessary, for example to replace a battery or transfer the alarm to another vehicle.

Provision of an outer casing serves to protect the alarm from ingress of water, for example, in a car wash facility or due to heavy rain or snow. The alarm may be less recognisable as such as the sound emitting apertures are concealed, reducing the likelihood of damage and making the source of the alarm less easy to detect.

The outer surface of the casing may be rounded, not having sharp edges or corners in order to make it more difficult for a would-be thief to remove the alarm unit from a vehicle.

The base may be flexible, the alarm further comprising one or more biassing means adapted to apply a force to urge the base into a curved configuration. The allows the base to have a complementary fit with a curved vehicle body panel to which the alarm is attached in use.

Several advantages are associated with the aforementioned complementary fit. Firstly, there may be a reduced tendency for the security alarm to be inadvertently knocked loose from the vehicle body. Secondly, increasing the surface area of the base which is in contact with the vehicle exterior may increase the sensitivity of the security alarm to motion or force applied to the exterior of the vehicle. Furthermore, the base is put under increased tension when bent into a curved configuration, which may also increase the sensitivity of the security alarm to motion applied to the exterior of the vehicle.

Preferably the biasing members are arranged to flex the base upwardly into the housing so that the base forms a concave surface. The base may be flexed upwardly to form a concave surface with a symmetrical or non-symmetrical longitudinal cross-section. This may allow a user to change the degree of flexure applied to the base to increase or decrease the curvature of the base. This may enable the base to form a close fit with a variety of contoured surfaces on the vehicle exterior.

The biasing means may comprise a plurality of first interlocking members located on the casing and the base.

The first interlocking members may comprise one or more projections and one or more receiving sections, each projection being arranged to be received and retained within a receiving section. Preferably the projections are located on the base and the receiving sections are located on the casing. Alternatively the projections are located on the casing and the receiving sections are located on the base.

The one or more receiving sections may be selected from slots, holes or recesses. The one or more projections may be selected from ribs, studs or clips.

The first interlocking members may be located on opposed sides of the casing and the base.

The first interlocking members on opposed sides may be arranged in a stacked configuration. This may allow a user to adjust the degree of flexure applied to the base to increase or decrease the curvature of the base.

The biasing means may comprise a plurality of second interlocking members located substantially centrally on the casing and the base. The second interlocking members may comprise one or more threaded holes and one or more screws or bolts, each screw or bolt being configured to rotatably engage within a respective threaded hole.

Preferably the one or more threaded holes are located on the base and each screw or bolt is positioned to extend through a hole in the casing so that each screw or bolt may rotatably engage within a threaded hole. Alternatively the one or more threaded holes may be located on the casing, each screw or bolt extending through a hole in the base so that each screw or bolt may rotatably engage within a threaded hole. This may allow a user to change the degree of flexure applied to the base to increase or decrease the radius of curvature of the base. For example, if a user wishes to increase the degree of flexure in the base the user may screw the screw or bolt into the threaded hole. Likewise if a user wishes to decrease the degree of flex in the base the user may unscrew the screw or bolt out of the threaded hole.

Each audio element may be located within an aperture of the casing. This may facilitate propagation of the alarm signal away from the interior of the housing. A seal may be provided around each audio element located within an aperture. The seal may be annular in shape. The seal may provide ingress protection up to and including IP55 protection.

Each aperture may have a flange extending from a mouth of the aperture into the interior space of the housing. The flange may be located around the circumference of the mouth. The cross-sectional dimension of the flange may decrease so that the flange is tapers in a direction towards an outer edge of the casing. This may facilitate propagation of the alarm signal in one or more directions.

Each aperture may be located on an upper surface of the casing, the upper surface being located opposite the base.

Each aperture may be located on a curved or chamfered region of the upper surface of the casing. The curved region may curve in a direction towards the base. This may facilitate propagation of the alarm signal in one or more directions.

Each aperture may be located adjacent a first interlocking member.

The attachment means may comprise one or more adhesive pads or one or more magnets to attach the security alarm to the vehicle exterior.

The motion sensing component may provide ingress protection up to and including IP55 protection. The housing may provide ingress protection up to and including IP55 protection.

IP55 protection is defined as providing protection from low pressure water jets from any direction, limited ingress protection.

The security alarm may further comprise a cover. The cover may have at least one outwardly opening flared domed region, each domed region arranged to cover an aperture and thereby define an interior space within the domed region.

The motion sensing component may be a vibration alarm sensor or a tremor alarm sensor. The generated alarm signal may be one or both of an audio alarm or signal to a mobile phone or other receiver. The motion sensing component may include a GPS receiver.

The motion sensing component may be turned on and off using an actuator button. The motion sensing component may be adjusted to a predetermined sensitivity or tolerance value which, when exceeded due to movement of the housing, generates the alarm signal. Alternatively, or in addition to, the motion sensing component may be remotely turned on or off and/or adjusted to a predetermined sensitivity or tolerance using a remote control. Alternatively, or in addition to, the motion sensing component may be remotely turned on or off and/or adjusted to a predetermined sensitivity or tolerance via a mobile device, for example a phone.

In an embodiment there is provided a security alarm for a vehicle, the security alarm comprising: a housing having: a casing having an interior and an exterior, and at least two apertures located at either end of the casing and extending between the interior and the exterior, each aperture being located on a curved or chamfered region of an upper surface of the casing; a flexible base comprising an attachment means to attach the housing to a surface of a vehicle; the casing and the base defining an interior space; and one or more biasing means adapted to apply a force to urge the base into a curved configuration; wherein the biasing means comprises a plurality of first interlocking members located on opposed sides of the casing and the base, the first interlocking members comprising one or more projections and one or more receiving sections, each projection being arranged to be received and retained within a receiving section, and a plurality of second interlocking members located substantially centrally on the casing and the base, the second interlocking members comprising one or more threaded holes and one or more screws or bolts, each screw or bolt being configured to rotatably engage a threaded hole; and at least two motion sensing components comprising an audio element, the at least two motion sensing components being located within the interior space of the housing so that each audio element is located within an aperture of the casing, the motion sensing component being configured to detect movement of the housing and to generate an alarm signal from the audio element in response to said movement.

### BRIEF DESCRIPTION OF THE DRAWINGS

The invention is further described by means of example, but not in any limitative sense with reference to the accompanying drawings, in which: FIG. 1 is an exploded perspective view of the security alarm according to the invention;

FIG. 2 is a further perspective view of the security alarm of FIG. 1 with casing removed;

FIG. 3 is a perspective view of the base of FIG. 1;

FIG. 4 is a perspective view of the casing of FIG. 1;

FIG. 5 is a perspective view of the motion sensing components and positioning member of FIG. 1;

FIG. 6 is a perspective view of the positioning member of FIG. 1;

FIG. 7 is a perspective view showing components of the alarm;

FIG. 8 is a plan view and cross sections of the alarm;

FIG. 9 is an exploded view of the alarm; and

FIGS. 10 and 11 show the passage of alarm signal from the assembled unit and inner casing respectively.

### DETAILED DESCRIPTION OF THE PREFERRED EMBODIMENTS

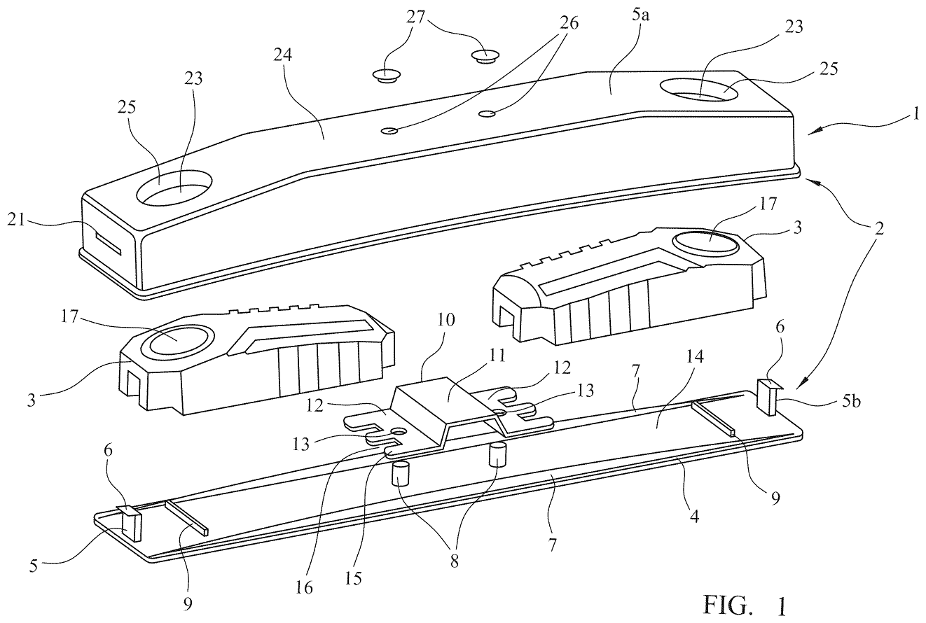

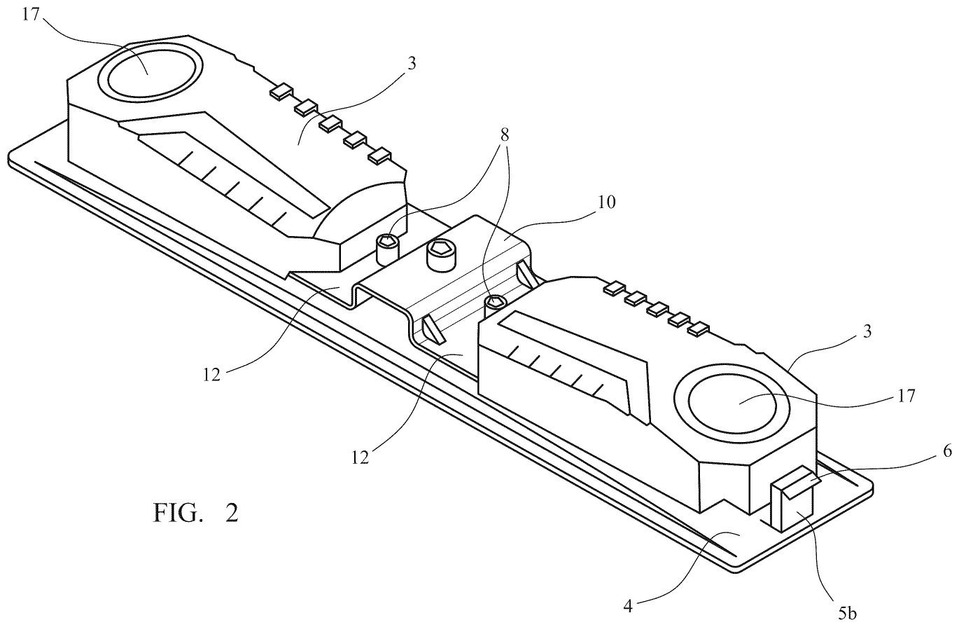

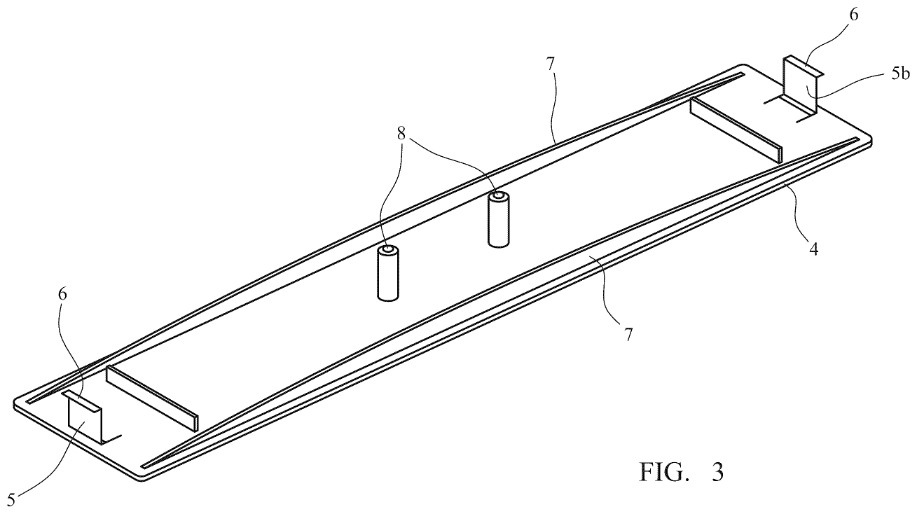

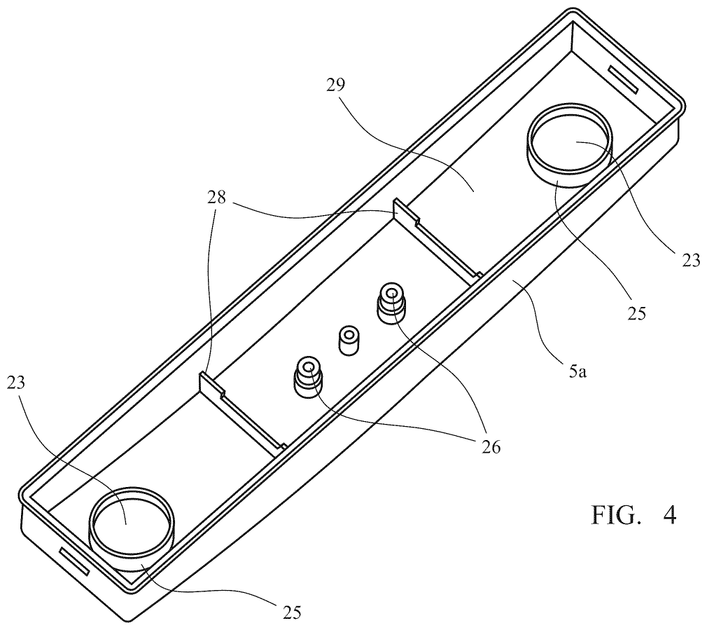

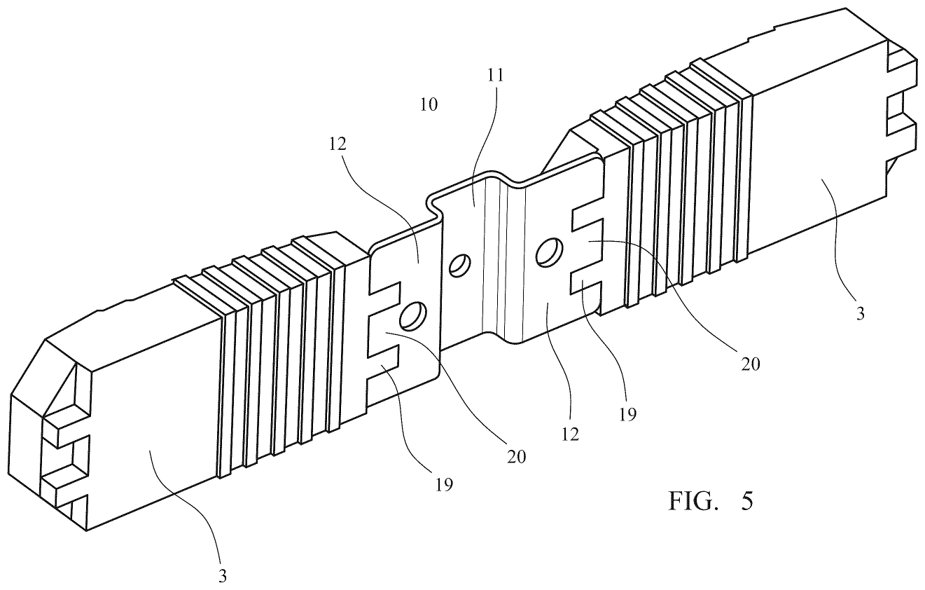

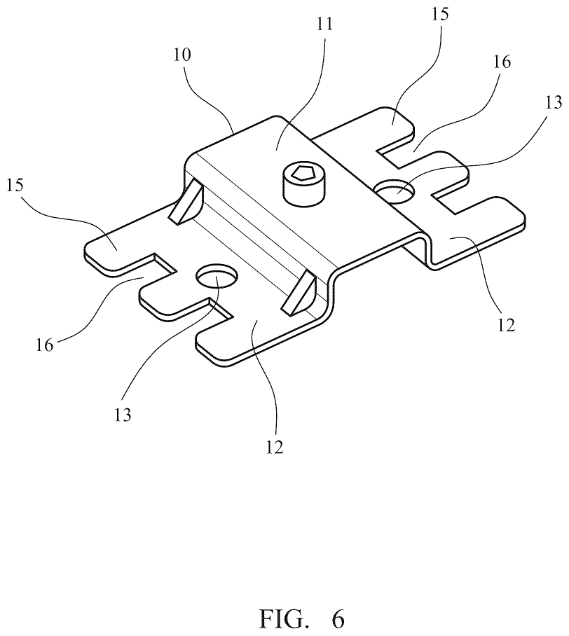

FIGS. 1 to 6 show a security alarm 1 according to the invention with the outer casing removed. The security alarm (1) comprises a housing (2) and two motion sensing components (3). The housing includes a flexible base (4) and a casing (5a). The base (4) is rectangular is shape, although other shapes are envisaged such as square or polygonal. The base (4) comprises a pair of upwardly extending projections (5b) at opposed ends of the base (4). Each projection (5b) includes a ribbed end (6). The base (4) further comprises a pair of flanges (7) extending longitudinally along opposed sides of the base (4). The cross-sectional dimension of each flange (7) decreases so that the flange (7) is tapered in a direction towards either end of the base (4). A pair of adhesive pads (not shown) are provided on the underside of the base for attaching the security alarm (1) to an exterior surface of a vehicle. Other types of attachment means are envisaged, such as magnets. The base (4) further comprises a pair upwardly extending cylindrical projections (8), each cylindrical projection (8) comprising a threaded hole. A pair of stops (9) are provided at either end of the base (4) adjacent the projections (8).

The security alarm (1) further comprises a positioning member (10). The positioning member (10) comprises a central body (11) and a pair of engagement members (12) on opposed sides of the body (11). Each engagement member (12) includes a hole (13) which is dimensioned to receive a cylindrical projection (8) of the base (4) so that the positioning member (10) may be pushed downwardly over the cylindrical projections (8). Preferably, the positioning member (10) is pushed downwardly over the cylindrical projections (8) so that the engagement members (12) contact an inner surface (14) of the base (4). Each engagement member (12) includes a plurality of tabs (15) and slots (16) which are arranged in a plane offset to a plane in which the longitudinal cross-sectional dimension of the central body (11) occupies.

The motion sensing components (3) comprise an audio element (17) and an annular channel (18) located around the audio element (17). The motion sensing component (3) further comprises an array of tabs (19) and slots (20) which are complementary in shape to the tabs (15) and slots (16) of the positioning member (10). Each motion sensing component (3) is positioned so that the tabs (19) and slots (20) of the motion sensing component (3) interlock with the tabs (15) and slots (16) of the positioning member (10). The back of the motion sensing component (3) opposite the tabs (19) and slots (20) is arranged to abut a stop (9). The aforementioned arrangement helps to prevent lateral or upwards movement of the motion sensing components (3) within the housing (2).

The casing (5a) is substantially rectangular in shape, although other shapes are envisaged such as square or polygonal. The casing (5a) comprises a pair of slots (21) located on an interior surface of opposed side walls (22). The casing (5a) further comprises a pair of apertures (23) located at opposite ends of the casing (5a). Each of the apertures (23) extends through an upper wall (24) of the casing (5a) opposite the base (4). Each aperture (23) has a flange (25) extending from a mouth of the aperture (23) into the interior space of the housing (2). The flange (25) is located around the circumference of the mouth and the cross-sectional dimension of the flange (25) decreases so that the flange (25) is tapered in a direction towards the opposed side walls (22). The upper wall (24) of the casing (5a) comprises a pair of holes (26) extending therethrough. Each hole (26) being dimensioned to receive a screw (not shown). A pair of fascias (27) are locatable within the holes (26) to provide a flush finish to the casing (5a). A pair of support slats (28) are located on an interior surface (29) of the upper wall (24).

To attach the casing (5a) to the base (4), the casing (5a) is lowered over the base (4) so that the flanges (25) are located within the annular channels (18) of the motion sensing components (3) and the audio element (17) is positioned within each apertures (23). During lowering of the casing (5a) the ribbed ends (6) of each projection (5b) are received and retained within the slots (21) of the casing (5a). Locating the ribbed ends (6) in the slots (21) provides a biasing force which flexes the base (4) upwardly into the interior of housing (2) so that the base (4) has a concaved curvature. A user may then rotatably engage the screws into the threaded holes of the cylindrical projections (8), which provides an additional biasing force to flex the base (4) upwardly. Use of two biasing means has the advantage of enabling the base (4) to be flexed to different degrees and thereby allows the curvature of the base (4) to be matched to a multitude of contoured surfaces. In particular, the screw/thread biasing arrangement enables the base (4) to be flexed by minutiae increments.

Various modifications will be apparent to those skilled in the art. In an alternative embodiment the base (4) may have side walls with one or more projections, such as ribs, located on the exterior of opposed sides. The projections being dimensioned received and retained within the slots (21) of the casing (5a). The casing (5a) may also have a plurality of slots (21) in a stacked arrangement on the interior surface of the opposed side walls (22). This allows a user to introduce additional biasing force by positioning a projection in a higher slot and thereby increasing the flex in the base.

Other receiving members (other than the slots 21) and projections may be used. The receiving member may for example be a hole or recess. The projections may for example be studs or clips.

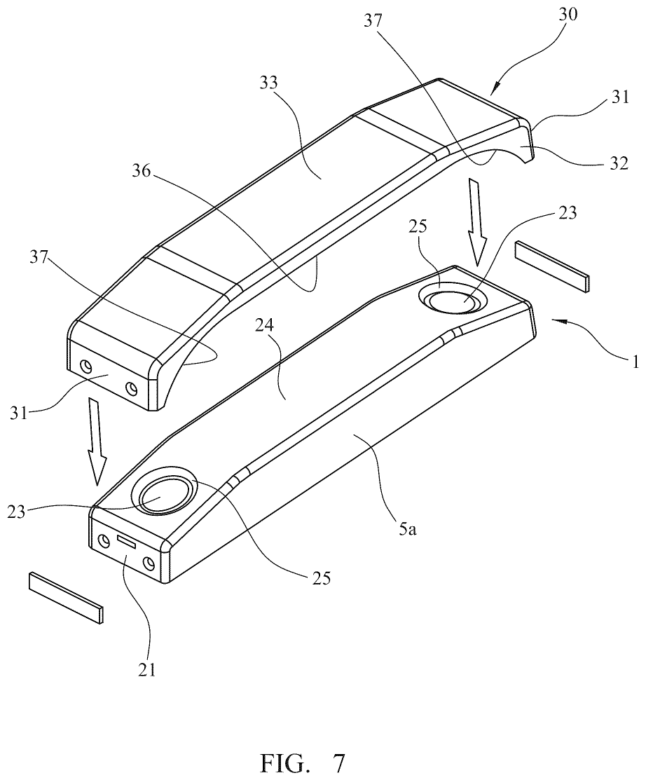

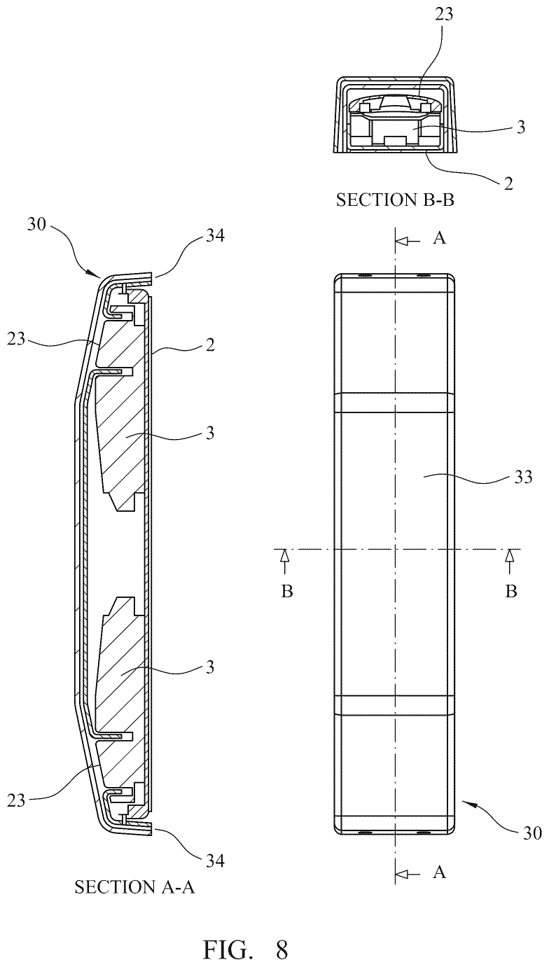

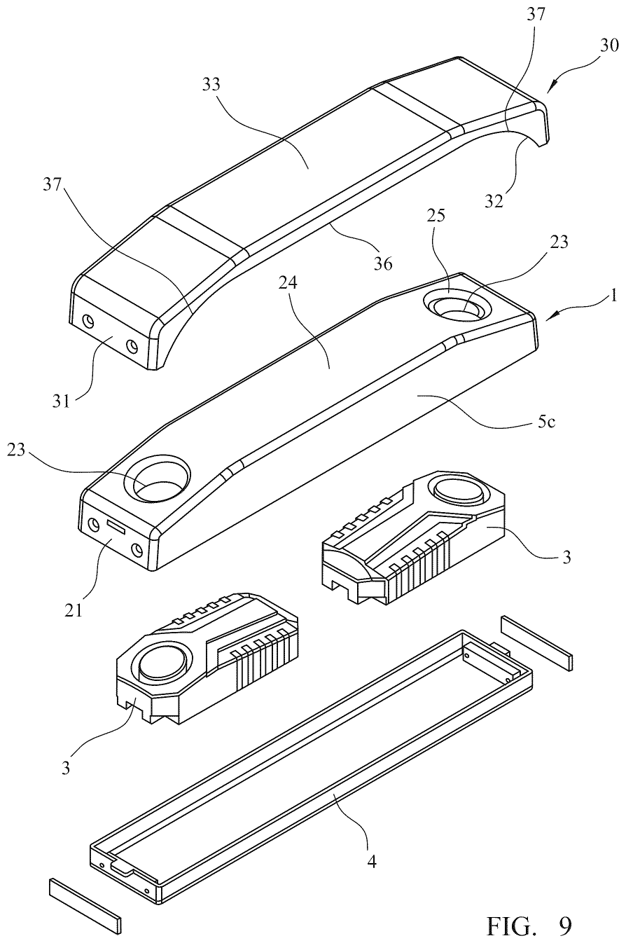

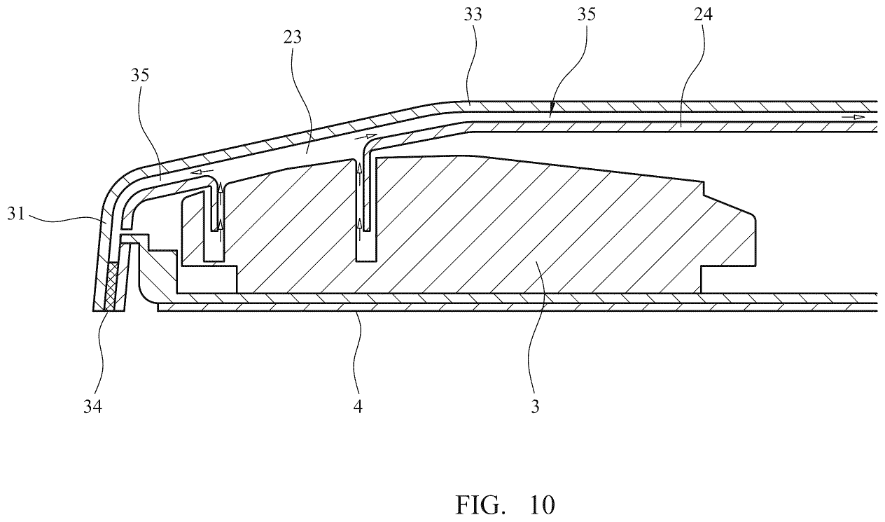

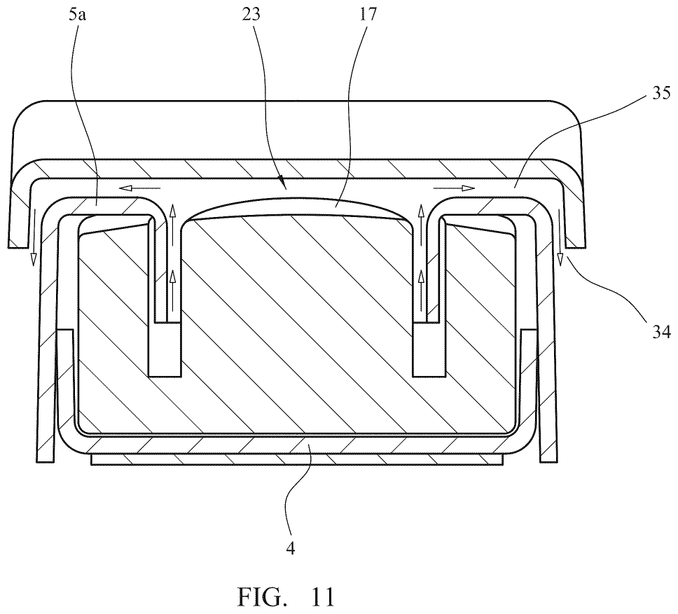

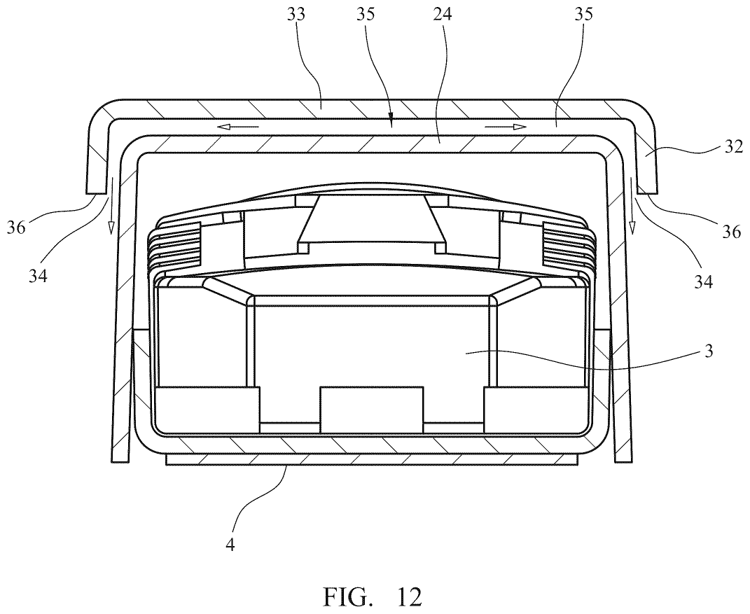

FIG. 7 is a perspective view showing the inner casing (5a) of the security alarm (1).

FIG. 8 is a plan view and cross section of the alarm shown in FIG. 7.

The inner casing and alarm components are as described with reference to FIGS. 1 to 6.

The outer casing (30) is generally rectangular in plan view. End portions (31) and side portions (32) extend downwardly from the top or upper portion (33) to form a rectangular casing which fits over the upper surface (24) and sides of the inner casing (5a) of the alarm. The inner surface and side surfaces of the outer casing (30) and the upper surface and side surfaces of the inner casing (24), (5a) define a spatial volume (35) extending from the apertures (23) to an outlet (34) extending around the base of the alarm. The outlet extends generally downwardly towards the body of a vehicle to which the alarm is attached in use. The dimension of the spatial volume (35) between the surfaces is in the range of 1 mm to 5 mm, preferably 1.5 mm to 2.5 mm, more preferably about 2 mm. The dimension is generally constant from the aperture to the outlet.

In use, an audible alarm signal emitted by each of the audio elements (17) into the annular channel (18) passes through the aperture (23) into the spatial volume (35).

The upper surface of inner casing (5a) and lower surface of the outer casing (33) form a channel to conduct the alarm to the downwardly facing outlet (34) extending along the sides and ends of the casings to direct the alarm signal towards the surface of a vehicle body (not shown) to which the alarm is secured in use.

The lower edge of the outer casing (32) is curved upwardly away from the base (4) so that a central portion (36) is at a greater distance from the base (4) and consequently from the surface of the vehicle body panel (not shown) and the end portions (37). This arrangement allows a major part of the audible sound signal to be emitted from the central portion (36) towards the vehicle body panel with a smaller proportion of the signal to be emitted from the end portions (37) having a smaller radius of curvature, in a wider range of directions relative to the alarm body and vehicle body panel.

1. A security alarm for a vehicle, the security alarm comprising:
a housing having:
inner and outer casings;
the inner casing having an interior and an exterior surface, and at least one aperture extending between the interior and the exterior surfaces;
the outer casing configured to overlie the inner casing;
the outer casing having interior and exterior surfaces and arranged to be secured to the inner casing so that the interior surface of the exterior casing overlies at least a part of the exterior surface of the inner casing with the exterior casing covering the aperture;
wherein the exterior surface of the inner casing and the interior surface of the outer casing define a spatial volume communicating between the aperture and the exterior surface of the inner casing and the interior surface of the outer casing, being separated by a dimension between 1 mm and 5 mm;
a base comprising an attachment to attach the housing to a surface of a vehicle, the casing and the base defining an interior space; and
at least one motion sensing component comprising an audio element, the at least one motion sensing component being located within the interior space of the housing so that each audio element is located adjacent an aperture of the casing;
the motion sensing component being configured to detect movement of the housing and to generate an alarm signal from the audio element in response to said movement.

2. The security alarm as claimed in claim 1, wherein the dimension is from 1.5 mm to 2.5 mm.

3. The security alarm as claimed in claim 2, wherein the dimension is 2 mm.

4. The security alarm system as claimed in claim 3, wherein the outer casing comprises a top panel and one or more sides which extend downwardly from the top panel to form a cover for the inner casing.

5. The security alarm as claimed in claim 4, wherein the lower edges of the one or more sides are straight and parallel to the base of the inner casing.

6. The security alarm system as claimed in claim 4, wherein the lower edge or edges of the one or more sides is curved with ends thereof being closer to the base of the inner casing and an intermediate part of the side.

7. The security alarm as claimed in claim 5, wherein the sides of the outer casing are in parallel spaced relation to corresponding sides of the inner casing being separated by a distance of 1 mm to 5 mm.

8. The security alarm as claimed in claim 4, wherein the inner and outer casings are rectilinear in plan view.

9. The security alarm as claimed in claim 8, wherein the dimension between the lower edge or edges and the inner casing, along the length of the lower edge is substantially constant.

10. The security alarm as claimed in claim 9, wherein the dimension along the lower edges is from 1.5 mm to 2.5 mm.

11. The security alarm as claimed in claim 10, wherein the dimension along the length of the lower edge is 2 mm.

12. The security alarm as claimed in claim 6, wherein the radius of curvature of the curved edge is greater at the ends thereof than in a central portion.

13. The security alarm as claimed in claim 11, wherein the base is flexible; the alarm further comprising one or more biasing means adapted to apply a force to urge the base into a curved configuration.

14. The security alarm as claimed in claim 6, wherein the sides of the outer casing are in parallel spaced relation to corresponding sides of the inner casing being separated by a distance of 1 mm to 5 mm.

15. The security alarm as claimed in claim 1, wherein the inner and outer casings are rectilinear in plan view.

16. The security alarm as claimed in claim 5, wherein the dimension between the lower edge or edges and the inner casing, along the length of the lower edge is substantially constant.

17. The security alarm as claimed in claim 16, wherein the dimension along the lower edges is from 1.5 mm to 2.5 mm.

18. The security alarm as claimed in claim 17, wherein the dimension along the length of the lower edge is 2 mm.

19. The security alarm as claimed in claim 18, wherein the base is flexible; the alarm further comprising one or more biasing means adapted to apply a force to urge the base into a curved configuration.
